(19) United States
(12) Patent Application Publication
(10) Pub. No.: US 2015/0317570 A1
(43) Pub. Date: Nov. 5, 2015

(54) SCHEDULE ADJUSTMENT DEVICE, SCHEDULE ADJUSTMENT METHOD, AND SCHEDULE ADJUSTMENT PROGRAM

(71) Applicant: RAKUTEN, INC., Shinagawa-ku, Tokyo (JP)

(72) Inventors: Saori HASHIZUME, Shinagawa-ku, Tokyo (JP); Yusuke SASAMORI, Shinagawa-ku, Tokyo (JP)

(73) Assignee: Rakuten, Inc., Tokyo (JP)

(21) Appl. No.: 14/650,591

(22) PCT Filed: Sep. 30, 2013
(86) PCT No.: PCT/JP2013/076541

§ 371 Date: Jun. 9, 2015

(51) Int. Cl. G06Q 10/02

(52) U.S. Cl. CPC G06Q 10/02

(57) ABSTRACT

A schedule adjustment device is a device for assisting an organizer holding an event by inviting participants to decide a slot for holding the event, the slot at least containing information about date and time, which includes a notification means to, when a plurality of candidate slots for holding an event set by an organizer terminal used by the organizer satisfy predetermined unavailability conditions, notify the organizer terminal of that fact.

### TECHNICAL FIELD

The present invention relates to a schedule adjustment device, a schedule adjustment method, and a schedule adjustment program.

### BACKGROUND ART

When holding an event, an organizer presents proposed dates and times for the event to the other participants through the Internet or the like, acquires responses from the participants and adjusts the schedule. For example, a system that, when holding a dinner, allows an organizer to consult with the other participants about a restaurant, date and time and the like and make a reservation for a restaurant, date and time and the like is known (for example, see Patent Literature 1).

### CITATION LIST

### Patent Literature

PTL 1: Japanese Unexamined Patent Application Publication No. 2006-323805

### SUMMARY OF INVENTION

### Technical Problem

According to related art, it takes time to receive responses from all participants after presenting proposed dates and times to the participants. Therefore, even if a reservation was available for all proposed dates and times at the time when an organizer presented them, a reservation sometimes becomes unavailable for any proposed dates and times depending on responses from participants received after that, a change in the status of reservations and the like. In the case where it becomes impossible to make a reservation for any proposed dates and times, the organizer needs to decide new proposed dates and times and promptly present them to participants again in order for rescheduling.

In view of the above, an object of the present invention is to let an organizer recognize the need to present new proposed dates and times to participants early on in the adjustment of an event schedule.

### Solution to Problem

To solve the above problem, a schedule adjustment device according to one aspect of the present invention is a schedule adjustment device for assisting an organizer holding an event by inviting participants to decide a slot for holding the event, the slot at least containing information about date and time, which includes a notification means configured to, when a plurality of candidate slots for holding an event set by an organizer terminal used by the organizer satisfy predetermined unavailability conditions, notify the organizer terminal of that fact.

A schedule adjustment method according to one aspect of the present invention is a schedule adjustment method in a schedule adjustment device for assisting an organizer holding an event by inviting participants to decide a slot for holding the event, the slot at least containing information about date and time, the method including a notification step of when a plurality of candidate slots for holding an event set by an organizer terminal used by the organizer satisfy predetermined unavailability conditions, notifying the organizer terminal of that fact.

A schedule adjustment program according to one aspect of the present invention causes a computer to function as a schedule adjustment device for assisting an organizer holding an event by inviting participants to decide a slot for holding the event, the slot at least containing information about date and time, the program causing the computer to implement a notification function to, when a plurality of candidate slots for holding an event set by an organizer terminal used by the organizer satisfy predetermined unavailability conditions, notify the organizer terminal of that fact.

According to the above aspect, when predetermined unavailability conditions related to a plurality of candidate slots for holding an event are satisfied, that fact is notified to an organizer terminal. The organizer can thereby recognize that it has become impossible to hold an event in the set candidate slots. It is thereby possible to let the organizer recognize the need to make readjustment of the schedule early on.

In the schedule adjustment device according to another aspect, the schedule adjustment device can acquire reservation information related to slots for which reservations are accepted by communication with a reservation system that accepts reservations for slots for holding an event, the schedule adjustment device may further include an acquisition means configured to acquire reservation information related to slots for which reservations are accepted from the reservation system, and the unavailability conditions may be satisfied when the number of available reservation slots being the candidate slots not reserved in the reservation information acquired by the acquisition means falls below the necessary number of slots indicating the number of slots necessary to be reserved for holding an event.

According to the above aspect, the organizer of an event can recognize that it has become impossible to hold an event based on the fact that a reservation for the candidate slots is made by another person in the reservation system.

The schedule adjustment device according to another aspect may further include a presentation means configured to present the candidate slots to participant terminals used by participants of an event, and a receiving means configured to receive registration of participation information indicating whether or not to participate in the event to be held in the candidate slot from the participant terminals for each of the candidate slots, and the unavailability conditions may be satisfied when participation information indicating being able to participate is received from a number of participants exceeding the maximum number of persons allowed to participate in an event for the necessary number of slots indicating the number of slots necessary to be reserved for holding an event, or when the number of participants from whom participation information indicating being able to participate is received falls below the minimum number of persons required to hold an event for the necessary number of slots.

According to the above aspect, the organizer of an event can recognize that it has become impossible to hold an event based on the fact that the number of participants exceeds the maximum number of persons for holding an event or falls below the minimum number of persons for holding an event.

In the schedule adjustment device according to another aspect, the schedule adjustment device can acquire reservation information related to slots for which reservations are accepted by communication with a reservation system that accepts reservations for slots for holding an event, the schedule adjustment device may further include an acquisition means configured to acquire reservation information related to slots for which reservations are accepted from the reservation system, a presentation means configured to present the candidate slots to participant terminals used by participants of an event, and a receiving means configured to receive registration of participation information indicating whether or not to participate in the event to be held in the candidate slot from the participant terminals for each of the candidate slots, and the unavailability conditions may be satisfied when the number of available reservation slots being the candidate slots for which registration of the participation information indicating being unable to participate is not made and which are not reserved in the reservation information acquired by the acquisition means falls below the necessary number of slots indicating the number of slots necessary to be reserved for holding the event and set by the organizer terminal or the schedule adjustment device.

According to the above aspect, the participation information from participants for the candidate slots set by the organizer terminal and the reservation information for the candidate slots from the reservation system are acquired, and when it is determined based on those acquired information that the number of available reservation slots falls below the necessary number of slots, that fact is notified to the organizer terminal. The organizer can thereby recognize that a reservation for the set candidate slots has become impossible. It is thereby possible to let the organizer recognize the need to present new proposed dates and times to participants and make readjustment of the schedule early on.

In the schedule adjustment device according to another aspect, the notification means may make determination as to whether the unavailability conditions are satisfied when the acquisition means acquires the reservation information from the reservation system.

The time when the reservation information from the reservation system is received is when there is a possibility that the unavailability conditions are satisfied due to a change in status. According to this aspect, by making determination at such timing, it is possible to let the organizer recognize the need to make readjustment of the schedule at the appropriate timing.

In the schedule adjustment device according to another aspect, the notification means may make determination as to whether the unavailability conditions are satisfied when the receiving means receives registration of the participation information from the participant terminals.

The time when registration of the participation information is received is when there is a possibility that the unavailability conditions are satisfied due to a change in status. According to this aspect, by making determination at such timing, it is possible to let the organizer recognize the need to make readjustment of the schedule at the appropriate timing.

In the schedule adjustment device according to another aspect, the notification means may make determination as to whether the unavailability conditions are satisfied when the receiving means receives registration of the participation information from a participant terminal whose participation information has not been registered.

The time when registration of the participation information from a participant terminal whose participation information has not been registered is received is when there is a possibility that the unavailability conditions are satisfied due to the registration. According to this aspect, by making determination at such timing, it is possible to let the organizer recognize the need to make readjustment of the schedule at the appropriate timing.

In the schedule adjustment device according to another aspect, the notification means may make determination as to whether the unavailability conditions are satisfied when the acquisition means acquires the reservation information from the reservation system after registration of the participation information from all of the participant terminals to whom candidate slots have been presented by the presentation means is received.

The period after participation information from all participants is received is the period when the organizer can make a reservation for any one of the candidate slots. According to the above aspect, because determination as to whether the unavailability conditions are satisfied is made when the reservation information from the reservation system is received during such a period, it is possible to reduce the processing load for the determination process and let the organizer recognize the need to make readjustment of the schedule at the appropriate timing.

In the schedule adjustment device according to another aspect, the candidate slots may have a temporal attribute and a geographic attribute, the schedule adjustment device may further include an extraction means configured to extract one or more slots having an attribute temporally or geographically closest to any candidate slot of the candidate slots among the slots available for reservation in the reservation system that accepts reservations for slots for holding an event, and the notification means may notify recommendation information containing the slots extracted by the extraction means as candidate slots to the organizer terminal.

According to the above aspect, because the candidate slots which have the attribute temporally or geographically close to any of the candidate slots set by the organizer and which can reserved are notified to the organizer after the unavailability conditions are satisfied, the organizer can easily recognize the candidate slots which participants are likely to be able to participate in.

The schedule adjustment device according to another aspect may further include a presentation means configured to present the candidate slots to participant terminals used by participants of an event, and a receiving means configured to receive registration of participation information indicating whether or not to participate in the event to be held in the candidate slot from the participant terminals for each of the candidate slots, and when additional setting of candidate slots from the organizer terminal is received after the notification means notifies the organizer terminal of a fact that the unavailability conditions are satisfied, the presentation means may present the candidate slots related to the additional setting to the participant terminals from whom registration of the participation information has been received by the receiving means.

According to the above aspect, when additional setting of candidate slot information from the organizer terminal is received after the unavailability conditions are satisfied, the candidate slot information related to the additional setting is presented to the participant terminals from whom registration of the participation information has been received. Thus, the information about the added candidate slots is sent only to the participants to whom a change in the candidate slots should be notified. It is thereby possible to reduce the traffic for presenting the candidate slots.

### Advantageous Effects of Invention

According to one aspect of the present invention, it is possible to let an organizer recognize the need to present new proposed dates and times to participants early on in the adjustment of an event schedule.

### BRIEF DESCRIPTION OF DRAWINGS

FIG. 1 is a view showing a configuration of a system including a schedule adjustment device.

FIG. 2 is a block diagram showing a functional configuration of the schedule adjustment device.

FIG. 3 is a view showing a hardware configuration of the schedule adjustment device.

FIG. 4 is a view showing a configuration of a candidate slot information storage unit and an example of data stored therein.

FIG. 5 is a view showing an example of the candidate slot information storage unit after registration of participation information is received from user terminals of all participants.

FIG. 6 is a view showing a configuration of the candidate slot information storage unit and an example of data stored therein in the case where “2” is set as the necessary number of slots.

FIG. 7 is a view showing a configuration of the candidate slot information storage unit and an example of data stored therein after participation information and reservation information are updated in the case where “2” is set as the necessary number of slots.

FIG. 8 is a view showing a configuration of the candidate slot information storage unit and an example of data stored therein to describe another example of determination by a determination unit.

FIG. 9 is a flowchart showing an example of a process of a schedule adjustment method.

FIG. 10 is a view showing a configuration of a schedule adjustment program.

### DESCRIPTION OF EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted.

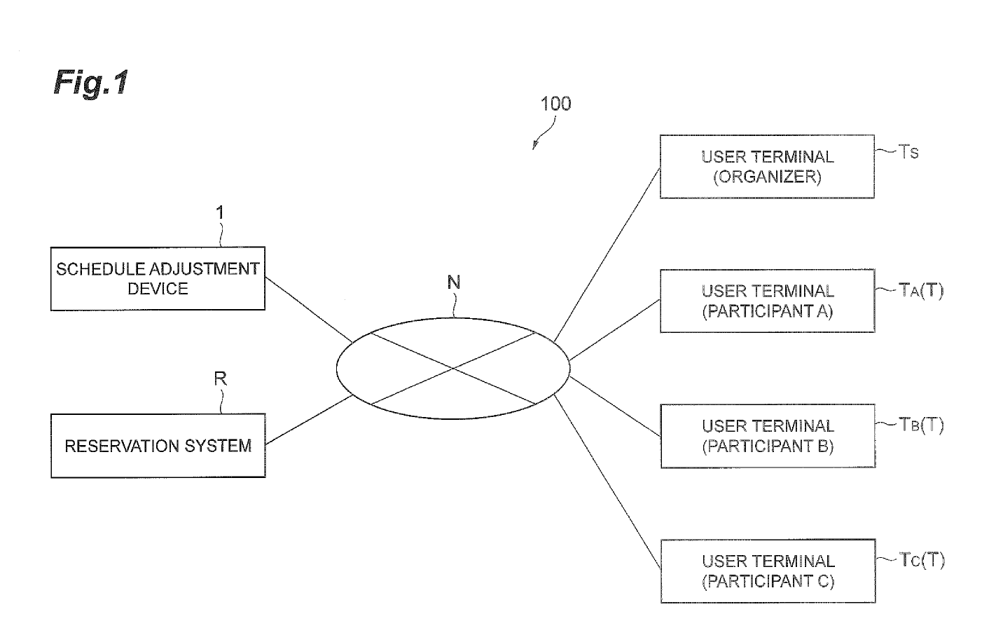

FIG. 1 is a view showing a configuration of a schedule adjustment system 100 that includes a schedule adjustment device 1 according to this embodiment. As shown in FIG. 1, the schedule adjustment system 100 includes the schedule adjustment device 1, user terminals T_{S} and T and a reservation system R. The user terminals T_{S} and T and the schedule adjustment device 1 are connected through a network N such as the Internet. The reservation system R is a system that accepts reservations for candidate slots having the attributes such as date and time and a place for holding an event. Note that, although three user terminals T are shown in FIG. 1, the number of user terminals T is not limited.

The variety of the user terminals T is not particularly limited, and it may be a stationary or portable personal computer, or a mobile terminal such as an advanced mobile phone (smart phone), a cellular phone or a personal digital assistant (PDA), for example.

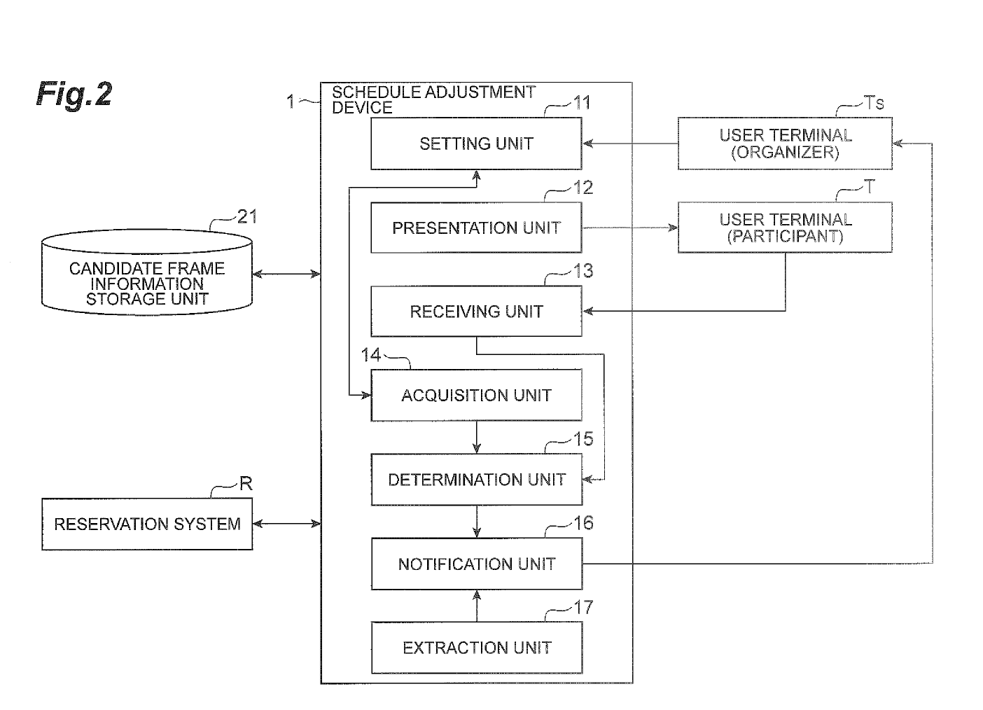

FIG. 2 is a block diagram showing a functional configuration of the schedule adjustment device 1 according to this embodiment. The schedule adjustment device 1 is a device for an organizer to present proposed dates and times for holding an event to the other participants through the Internet or the like, acquire responses from the participants and adjust the schedule, and it is implemented by a computer such as a server, for example. In this embodiment, the present invention is described using an example of schedule adjustment for golf course reservation, where an event is golf in a group of a plurality of persons. Note that the present invention is not limited to golf and golf course reservation.

As shown in FIG. 2, the schedule adjustment device 1 according to this embodiment functionally includes a setting unit 11, a presentation unit 12 (presentation means), a receiving unit 13 (receiving means), an acquisition unit 14 (acquisition means), a determination unit 15 (notification means), a notification unit 16 (notification means), and an extraction unit 17 (extraction means). Further, the schedule adjustment device 1 can access a candidate slot information storage unit 21. The functional units 11 to 17 of the schedule adjustment device 1 can access the candidate slot information storage unit 21 and the reservation system R.

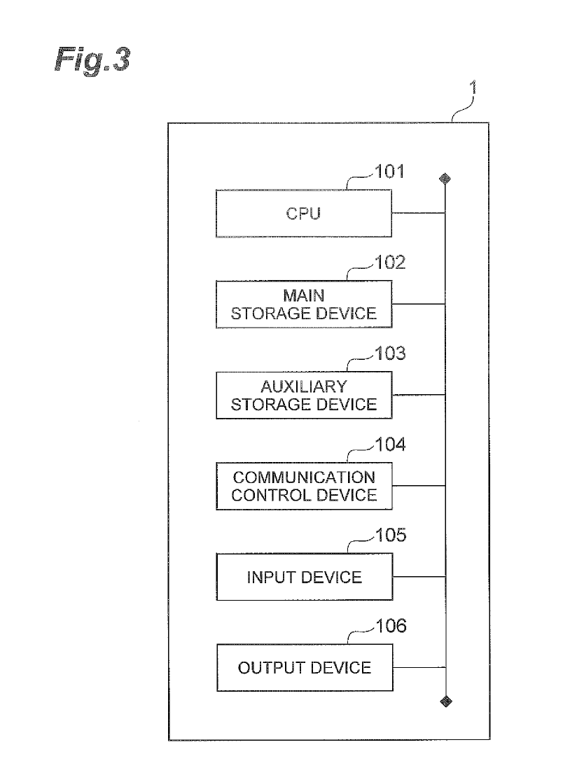

FIG. 3 is a view showing a hardware configuration of the schedule adjustment device 1. As shown in FIG. 3, the schedule adjustment device 1 is physically configured as a computer system that includes a CPU 101, a main storage device 102 such as memory like RAM and ROM, an auxiliary storage device 103 such as a hard disk, a communication control device 104 such as a network card, an input device 105 such as a keyboard and a mouse, an output device 106 such as a display and the like.

The functions shown in FIG. 2 are implemented by loading given computer software (schedule adjustment program) onto hardware such as the CPU 101 or the main storage device 102 shown in FIG. 3, making the communication control device 104, the input device 105 and the output device 106 operate under control of the CPU 101, and performing reading and writing of data in the main storage device 102 or the auxiliary storage device 103. Data and database required for the processing is stored in the main storage device 102 or the auxiliary storage device 103.

The functional units of the schedule adjustment device 1 are described hereinafter. The setting unit 11 is a part that receives setting of candidate slot information from a user terminal T_{S} (organizer terminal) which is used by the organizer of an event. The candidate slot information is information about a candidate slot for holding an event, which at least contains information about date and time and may further contain a geographic attribute. Further, the setting unit 11 receives the candidate slot information together with the necessary number of slots indicating the number of slots that is necessary to be reserved. Note that, although the setting unit 11 receives the necessary number of slots from the user terminal T_{S} in this embodiment, the necessary number of slots may be set as a specified value in the schedule adjustment device 1.

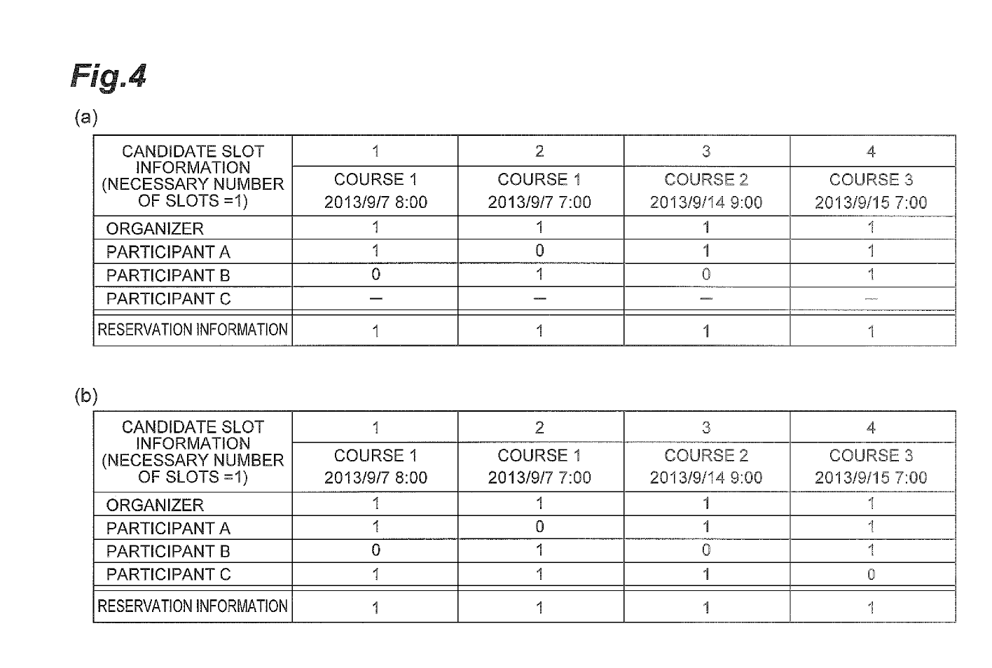

The setting unit 11 stores the received candidate slot information and the necessary number of slots into the candidate slot information storage unit 21. FIG. 4 is a view showing a configuration of the candidate slot information storage unit 21 and an example of data stored therein. An example of the candidate slot information and the necessary number of slots from the setting unit 11 is shown in the first row of the table of FIG. 4(a). The candidate slot information storage unit 21 stores the candidate slot information such as “Course 1, 2013/9/7, 8:00”, for example. In this candidate slot information, “Course 1” is geographic information indicating a certain golf course. Further, in this candidate slot information, “2013/9/7, 8:00” is temporal information indicating the date and time to start playing golf.

In addition to the above-mentioned candidate slot information, the candidate slot information storage unit 21 stores a plurality of candidate slot information such as “Course 1, 2013/9/7, 7:00”, “Course 2, 2013/9/14, 9:00” and “Course 3, 2013/9/5, 7:00”. Further, the candidate slot information storage unit 21 stores information such as “1” as the necessary number of slots.

Note that, when the candidate slot indicated by the candidate slot information which the user terminal T_{S} of the organizer has tried to set is a reserved frame in the reservation information acquired from the reservation system R by the acquisition unit 14, the setting unit 11 does not receive setting of the candidate slot information for the candidate slot. As a result, the candidate slot information only for a frame available for reservation is set in the candidate frame information storage unit 21. It is thereby possible to avoid a redundant procedure such as asking participants for a response as to whether or not to participate for the candidate slot that is already unavailable for reservation.

The presentation unit 12 is a part that presents the candidate slot information to user terminals T (participant terminals) that are used by participants of an event. To be specific, the presentation unit 12 presents the candidate slot information that has been received from the user terminal T_{S} by the setting unit 11 and stored into the candidate frame information storage unit 21 to the user terminals T. Specifically, in this embodiment, the presentation unit 12 presents the plurality of candidate slot information 1 to 4 (“Course 1, 2013/9/7, 8:00”, “Course 1, 2013/9/7, 7:00”, “Course 2, 2013/9/14, 9:00” and “Course 3, 2013/9/5, 7:00”) to the user terminals T_{A}, T_{B} and T_{C} of the participants A, B and C, respectively. The user terminals T to which the candidate slot information is presented may be set by the organizer through the user terminal T_{S}, for example.

The receiving unit 13 is a part that receives registration of participation information indicating whether or not to participate in the event of the candidate slot indicated by the candidate slot information from the user terminals T of participants for each of the candidate slot information. Then, the receiving unit 13 registers the participation information received from the user terminals T in the candidate frame information storage unit 21. An example of the registered participation information is shown in the second and lower rows of the table in FIG. 4(a). In this table, the participation information indicating that participation in the event is possible is represented by “1”, and the participation information indicating that participation in the event is not possible is represented by “0”.

In the candidate frame information storage unit 21 shown in FIG. 4(a), the participation information of the participant A which indicates that he/she can participate in the event of the candidate slot information 1, 3 and 4 and cannot participate in the event of the candidate slot information 2 is stored, for example. Further, the participation information of the participant B which indicates that he/she can participate in the event of the candidate slot information 2 and 4 and cannot participate in the event of the candidate slot information 1 and 3 is stored. The participation information of the participant C is not registered.

The acquisition unit 14 is a part that acquires reservation information about candidate slots for which reservations have been accepted from the reservation system R that accepts reservations for candidate slots of an event. The reservation information is information indicating the status of reservations from all users for the candidate slots indicated by the candidate slot information. The acquisition unit 14 stores the reservation information acquired from the reservation system R into the candidate frame information storage unit 21. In the example shown in FIG. 4(a), the reservation information indicating that the reservation slot of the event indicated by the candidate slot information is not yet reserved is represented by “1”, and the reservation information indicating that it is already reserved is represented by “0”. As shown in FIG. 4(a), all of the candidate slots registered are not yet reserved at the present moment.

The determination unit 15 is a part that determines whether a plurality of candidate slots for holding an event satisfy predetermined unavailability conditions. In this embodiment, the determination unit 15 determines whether the number of available reservation slots falls below the necessary number of slots in the candidate slots indicated by the candidate slot information. The available reservation slot is the candidate slot for which registration of the participation information indicating being unable to participate is not done and a reservation from a user is not made in the reservation system.

The notification unit 16 is a part that, when it is determined by the determination unit 15 that the unavailability conditions are satisfied, notifies that to the user terminal T_{S} of the organizer. In this embodiment, when it is determined by the determination unit 15 that the number of available reservation slots falls below the necessary number of slots in the candidate slots indicated by the candidate slot information, the notification unit 16 notifies that to the user terminal T_{S} of the organizer.

The determination unit 15 may set the time when registration of participation information from a participant terminal is received by the receiving unit 13 or when reservation information from the reservation system R is acquired by the acquisition unit 14 as the timing to perform the determination. The time when registration of participation information is received or when reservation information from the reservation system R is received is when the possibility that the number of available reservation slots falls below the necessary number of slots arises due to a change in status. In this embodiment, by making determination as to whether the number of available reservation slots falls below the necessary number of slots at this timing, it is possible to let the organizer recognize the need to present new proposed dates and times to the participants at the appropriate timing.

Further, the determination unit 15 may set the time when registration of participation information from a user terminal of a participant whose participation information has not been registered is received by the receiving unit 13 as the timing to perform the determination. The time when registration of participation information from a participant whose participation information is not yet registered is received is when the possibility that the number of available reservation slots falls below the necessary number of slots arises due to the registration. By making determination as to whether the number of available reservation slots falls below the necessary number of slots at this timing, it is possible to let the organizer recognize the need to present new proposed dates and times to the participants at the appropriate timing.

FIG. 4(b) is a view showing the candidate frame information storage unit 21 in which the participation information from the participant C whose participation information has not been registered in FIG. 4(a) is registered. As shown in FIG. 4(b), the receiving unit 13 stores the participation information received from the user terminal T_{C} of the participant C into the candidate frame information storage unit 21 for each of the candidate slot information. In this example, the participation information from the participant C indicates that he/she can participate in the event of the candidate slot information 1 to 3 and cannot participate in the event of the candidate slot information 4.

Since registration of the participation information from the user terminal T_{C} of the participant C is received, the determination unit 15 determines whether the number of available reservation slots falls below the necessary number of slots “1” in the candidate slots indicated by the candidate slot information. In the example shown in FIG. 4(a), the available reservation slot which all of the participants whose participation information is already registered can participate in and which is not yet reserved in the reservation system R is only the candidate slot information 4. Now, registration of the participation information indicating that he/she cannot participate in the event of the candidate slot information 4 is received from the participant C, and therefore the determination unit 15 determines that the number of available reservation slots falls below the necessary number of slots in the candidate slots indicated by the candidate slot information. Then, the notification unit 16 notifies that to the user terminal T_{S} of the organizer.

Further, the determination unit 15 may set the time when reservation information from the reservation system is acquired by the acquisition unit 14 in the case where registration of participation information from all of the participant terminals to which candidate slot information has been presented by the presentation unit 12 is received as the timing to perform the determination. The period after participation information from all participants is received is the period when the organizer can make a reservation for any one of the candidate slots. By setting the time when reservation information from the reservation system is received during that period as the timing to make determination, it is possible to reduce the processing load for the determination process and let the organizer recognize the need to present new proposed dates and times to the participants at the appropriate timing.

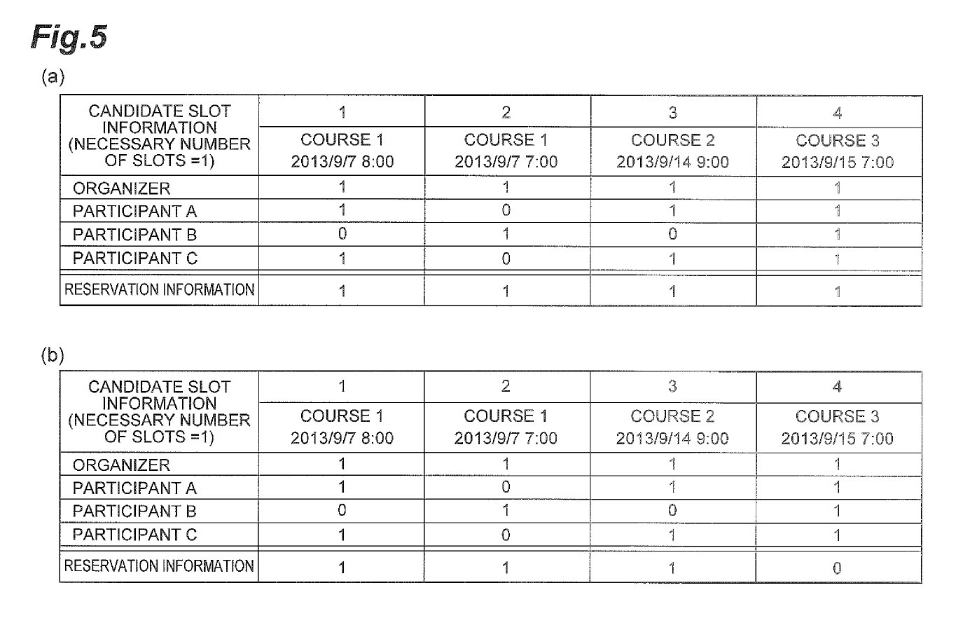

FIG. 5 is a view showing an example of the candidate slot information storage unit 21 when reservation information from the reservation system R is acquired by the acquisition unit 14 in the case where registration of participation information from the user terminals T of all participants is received, and data is updated by the acquired reservation information. In the example shown in FIG. 5(a), because the candidate slot which all participants can participate in is only the candidate slot information 4, and all candidate slots are not reserved in the reservation system R, the available reservation slot is only the candidate slot information 4. Then, when the acquisition unit 14 acquires the reservation information from the reservation system R, the determination unit 15 determines whether the number of available reservation slots falls below the necessary number of slots in the candidate slots indicated by the candidate slot information. In the example shown in FIG. 5(b), because the candidate slot indicated by the candidate slot information 4 has become reserved according to the reservation information from the reservation system R, the determination unit 15 determines that the number of available reservation slots falls below the necessary number of slots in the candidate slots indicated by the candidate slot information. Then, the notification unit 16 notifies that to the user terminal T_{S} of the organizer.

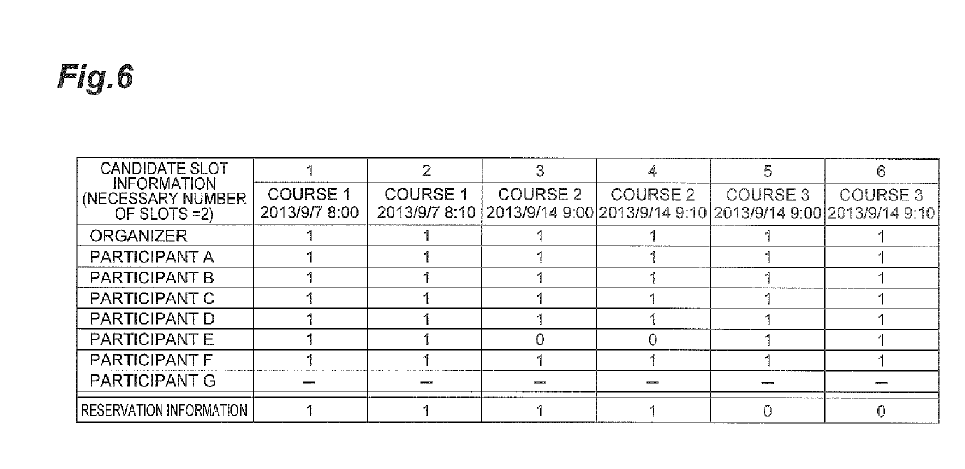

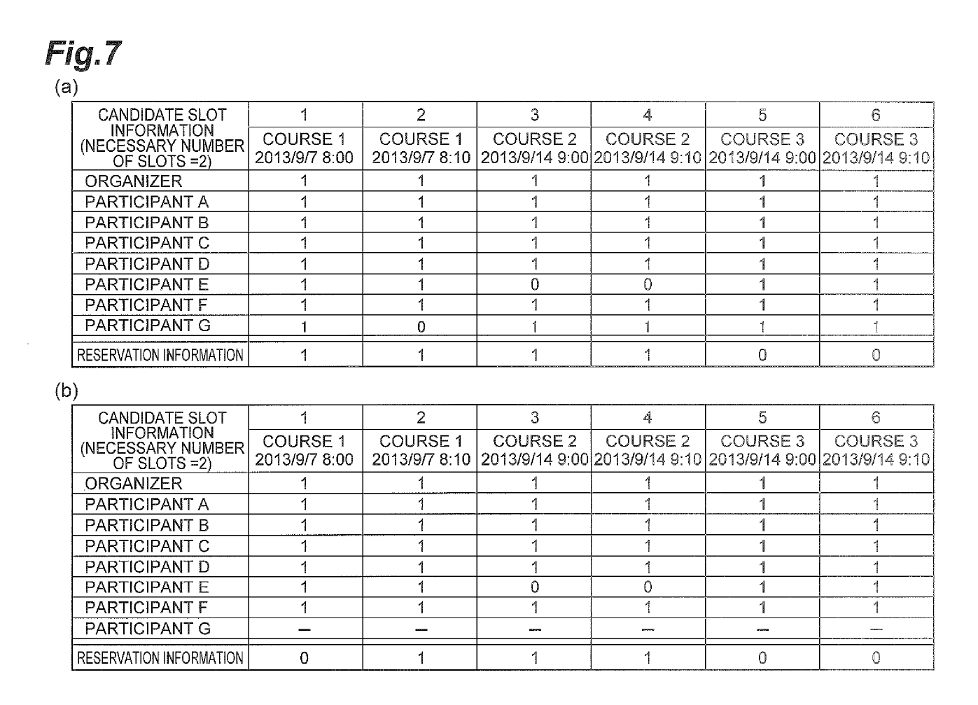

FIG. 6 and FIG. 7 are views showing an example of the candidate frame information storage unit 21 to describe the determination by the determination unit 15 in the case where “2” is set as the necessary number of slots. As shown in FIG. 6, in the candidate frame information storage unit 21, the candidate slot information 1 to 6 and the necessary number of slots “2” are set, and the participation information from the participants A to G for those candidate slot information are registered. At the present moment, the participation information of the organizer and the participants A to F are registered, and the participation information indicating being unable to participate is not registered for the candidate slot information 1, 2, 5 and 6. Further, according to the reservation information from the reservation system R, the candidate slots of the candidate slot information 5 and 6 are already reserved. Thus, the number of available reservation slots at the present moment is two: the candidate slot information 1 and 2.

Then, as shown in FIG. 7(a), when the participation information from the participant G is registered, the determination unit 15 makes determination as to whether the number of available reservation slots falls below the necessary number of slots in the candidate slots indicated by the candidate slot information. Because the participation information from the participant G indicates that he/she cannot participate for the candidate slot information 2, the number of available reservation slots is only one: the candidate slot information 1. Accordingly, the determination unit 15 determines that the number of available reservation slots falls below the necessary number of slots “2”. Then, the notification unit 16 notifies that to the user terminal T_{S} of the organizer.

On the other hand, as shown in FIG. 7(b), when the reservation information from the reservation system R is acquired by the acquisition unit 14, and the reservation information in the candidate frame information storage unit 21 is updated, the determination unit 15 makes determination as to whether the number of available reservation slots falls below the necessary number of slots in the candidate slots indicated by the candidate slot information. Because the reservation information indicates that the candidate slot of the candidate slot information 1 is already reserved, the number of available reservation slots is only one: the candidate slot information 2. Accordingly, the determination unit 15 determines that the number of available reservation slots falls below the necessary number of slots “2”. Then, the notification unit 16 notifies that to the user terminal T_{S} of the organizer.

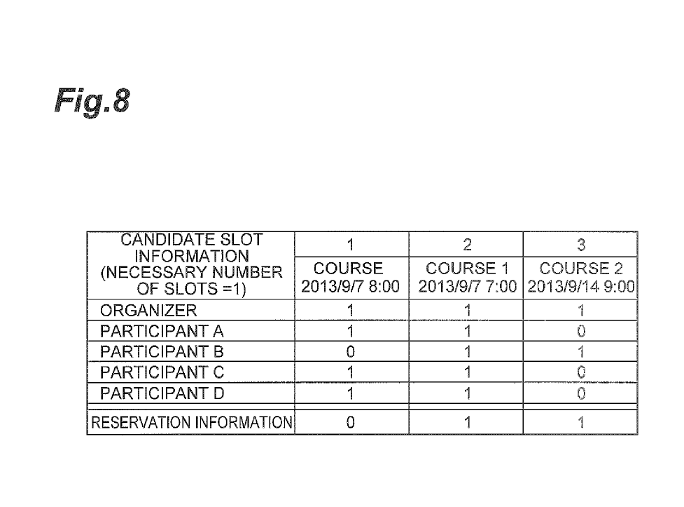

Another example of the determination about the unavailability conditions by the determination unit 15 is described hereinafter with reference to FIG. 8. FIG. 8 is a view an example of the candidate frame information storage unit 21 to describe the determination in the case where “1” is set as the necessary number of slots. The settings in this example are: the maximum number of persons for holding an event, which is the largest number of participants who can participate for the necessary number of slots, is four, and the minimum number of persons for holding an event, which is the smallest number of participants with which an event can be held for the necessary number of slots, is three. Those settings are made by the organizer terminal, for example. With those settings, when the number of participants for one candidate slot is more than four or when the number of participants for one candidate slot is less than three, the determination unit 15 determines that the event cannot be held in that candidate slot.

Because the example shown in FIG. 8 shows that a reservation is already made for the candidate slot 1 in the reservation information from the reservation system, the determination unit 15 determines that the event in the candidate slot 1 cannot be held. As for the candidate slot 2, because the number of participants who can participate is five, which is larger than the maximum number of persons for holding an event, four, the determination unit 15 determines that that the event in the candidate slot 2 cannot be held. As for the candidate slot 3, because the number of participants who can participate is two, which is smaller than the minimum number of persons for holding an event, three, the determination unit 15 determines that that the event in the candidate slot 3 cannot be held. Accordingly, the notification unit 16 notifies that the event cannot be held with the set candidate slots to the organizer terminal.

Referring back to FIG. 2, the extraction unit 17 is a part that, when it is determined by the determination unit 15 that the number of available reservation slots falls below the necessary number of slots in the candidate slots indicated by the candidate slot information, extracts one or more candidate slots having the attributes that are temporally or geographically closest to any of the candidate slots indicated by the candidate slot information received by the setting unit 11 among the candidate slots that can be reserved in the reservation system R. Note that the extraction unit 17 is not an essential element in the schedule adjustment device 1.

To be specific, when it is determined by the determination unit 15 that the number of available reservation slots falls below the necessary number of slots, for example, the extraction unit 17 extracts the candidate slot information for which at least a certain number or a certain proportion of participation information indicating being able to participate is stored in the candidate frame information storage unit 21. Then, the extraction unit 17 extracts the candidate slots having the attributes that are temporally closest to the attributes related to the date and time (for example, the date and time to start playing golf) of the extracted candidate slot information from the candidate slots that can be reserved in the reservation system R. Alternatively, the extraction unit 17 extracts the candidate slots having the attributes that are geographically closest to the attributes related to the place (for example, a golf course) of the extracted candidate slot information from the candidate slots that can be reserved in the reservation system R.

Then, the notification unit 16 notifies recommendation information containing the candidate slots extracted by the extraction unit 17 to the user terminal T_{S} of the organizer. Therefore, when the number of available reservation slots falls below the necessary number of slots due to registration of participation information from participants and a change in the status of reservations in the reservation system R, the organizer can easily recognize the candidate slots which participants are likely to be able to participate in. Accordingly, the organizer can set the candidate slots again through the user terminal T_{S}.

Further, when the setting unit 11 receives additional setting of candidate slot information from the user terminal T_{S} of the organizer, the presentation unit 12 presents the added candidate slot information to the user terminals T of participants. The participants can thereby recognize the added candidate slot information. Further, when presenting the added candidate slot information to the user terminals T of participants, the information may be presented only to the user terminals T from which the participation information for the candidate slot information that has been set before the candidate slot information is added has received. By limiting the user terminals to which the information is to be presented in this manner, the information about the added candidate slots is sent only to the participants to whom a change in the candidate slots should be notified. It is thereby possible to reduce the traffic for presenting the candidate slots.

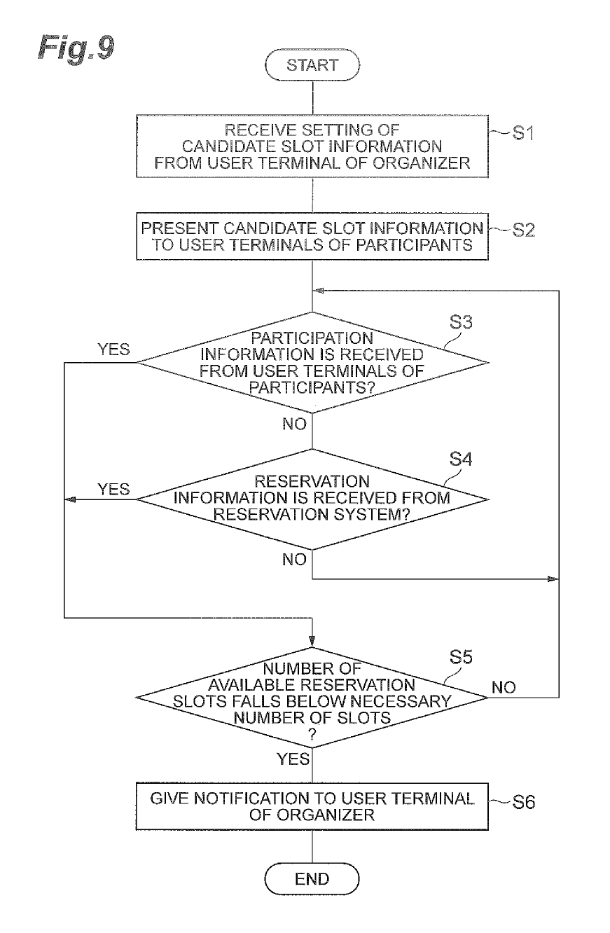

A schedule adjustment method according to this embodiment is described hereinafter with reference to FIG. 9. FIG. 9 is a flowchart showing an example of a process of the schedule adjustment method in the schedule adjustment device 1 shown in FIG. 2.

First, the setting unit 11 receives setting of candidate slot information from the user terminal T_{S} used by an organizer of an event (S1). Next, the presentation unit 12 presents the candidate slot information set in Step S1 to the user terminals T used by participants of the event (S2).

Then, in Step S3, when registration of participation information for the candidate slot information from the user terminals T is received by the receiving unit 13, the process proceeds to Step S5. On the other hand, when registration of participation information for the candidate slot information from the user terminals T is not received, the process proceeds to Step S4.

In Step S4, when reservation information from the reservation system R is acquired by the acquisition unit 14, the process proceeds to Step S5. On the other hand, when reservation information from the reservation system R is not acquired, the process returns to Step S3, and the determination in Steps S3 and S4 is repeated. Note that, the processing of Step S4 may be performed only when registration of participation information from the user terminals T of all participants to whom the candidate slot information has been presented is received. This reduces the processing load of the determination.

In Step S5, the determination unit 15 determines whether the number of available reservation slots falls below the necessary number of slots in the candidate slots indicated by the candidate slot information (S5). When it is determined that the number of available reservation slots falls below the necessary number of slots, the process proceeds to Step S6. On the other hand, when it is not determined that the number of available reservation slots falls below the necessary number of slots, the process returns to Step S3.

Then, the notification unit 16 notifies the user terminal T_{S} of the organizer that the number of available reservation slots falls below the necessary number of slots in the candidate slots indicated by the candidate slot information (S6). Note that, at the time of this notification, the notification unit 16 may also notify recommendation information containing the candidate slots extracted by the extraction unit 17 to the user terminal T_{S} of the organizer.

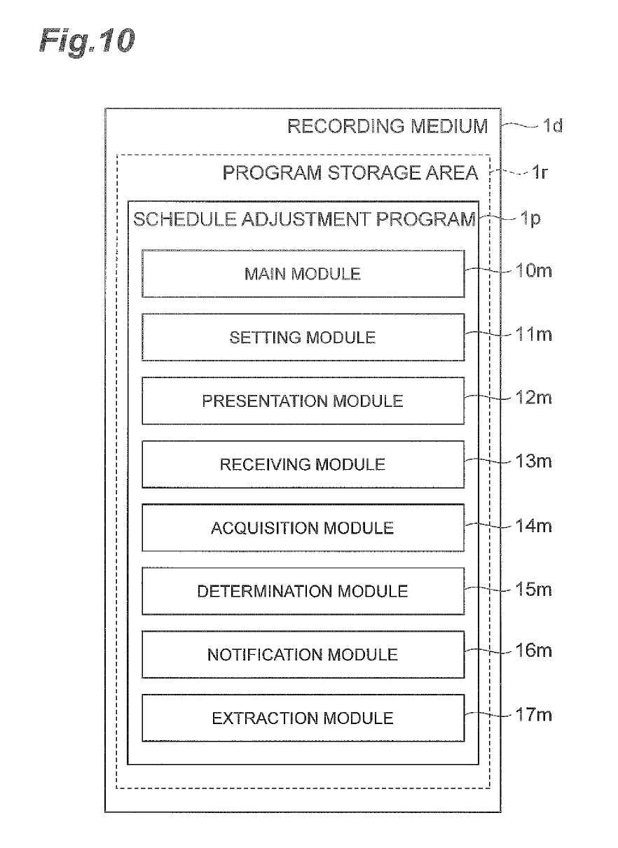

A schedule adjustment program that causes a computer to function as the schedule adjustment device 1 is described hereinafter with reference to FIG. 10. A schedule adjustment program 1p includes a main module 10m, a setting module 11m, a presentation module 12m, a receiving module 13m, an acquisition module 14m, a determination module 15m, a notification module 16m, and an extraction module 17m.

The main module 10m is a part that exercises control over the schedule adjustment processing. The functions implemented by executing the setting module 11m, the presentation module 12m, the receiving module 13m, the acquisition module 14m, the determination module 15m, the notification module 16m and the extraction module 17m are respectively equal to the functions of the setting unit 11, the presentation unit 12, the receiving unit 13, the acquisition unit 14, the determination unit 15, the notification unit 16 and the extraction unit 17 of the schedule adjustment device 1 shown in FIG. 2.

The schedule adjustment program 1p is provided through a recording medium 1d such as CD-ROM or DVD-ROM or semiconductor memory, for example. Further, the schedule adjustment program 1p may be provided as a computer data signal superimposed onto a carrier wave over a communication network.

According to the schedule adjustment device 1, the schedule adjustment method and the schedule adjustment program 1p of the embodiment described above, participation information from participants for candidate slots set by the user terminal T_{S} of an organizer and reservation information for the candidate slots from the reservation system R are acquired, and when it is determined based on those acquired information that the number of available reservation slots falls below the necessary number of slots, that fact is notified to the user terminal T_{S} of the organizer. The organizer can thereby recognize that a reservation for the set candidate slots has become impossible. It is thereby possible to let the organizer recognize the need to present new proposed dates and times to participants and make readjustment of the schedule early on.

An embodiment of the present invention is described in detail above. However, the present invention is not limited to the above-described embodiment. Various changes and modifications may be made to the present invention without departing from the scope of the invention. Although the present invention is described using an example of schedule adjustment for a reservation for a golf course, where an event is golf in a group of a plurality of persons in this embodiment, the present invention is also applicable to schedule adjustment for a reservation for an accommodation, a reservation for playing a futsal game and a court, and a reservation for a conference room and an auditorium.

### REFERENCE SIGNS LIST

1 . . . schedule adjustment device, 11 . . . setting unit, 12 . . . presentation unit, 13 . . . receiving unit, 14 . . . acquisition unit, 15 . . . determination unit, 16 . . . notification unit, 17 . . . extraction unit, 21 . . . candidate frame information storage unit, 1d . . . recording medium, 1p . . . schedule adjustment program, 10m . . . main module, 11m . . . setting module, 12m . . . presentation module, 13m . . . receiving module, 14m . . . acquisition module, 15m . . . determination module, 16m . . . notification module, 17m . . . extraction module, 100 . . . schedule adjustment system, N . . . network, R . . . reservation system, T_{A},T_{B},T_{C},T_{S},T . . . user terminal

1. A schedule adjustment device for assisting an organizer holding an event by inviting participants to decide a slot for holding the event, the slot at least containing information about date and time, comprising:
at least one memory operable to store program instructions;
at least one processor operable to access said memory and carry out said program instructions, said program instructions including:
notification instructions configured to cause at least one of said at least one processors to, when a plurality of candidate slots for holding an event set by an organizer terminal used by the organizer satisfy predetermined unavailability conditions, notify the organizer terminal of that fact.

2. The schedule adjustment device according to claim 1, wherein
the schedule adjustment device can acquire reservation information related to slots for which reservations are accepted by communication with a reservation system that accepts reservations for slots for holding an event,
the schedule adjustment device further comprises acquisition instructions configured to cause at least one of said at least one processors to acquire reservation information related to slots for which reservations are accepted from the reservation system, and
the unavailability conditions are satisfied when the number of available reservation slots being the candidate slots not reserved in the reservation information acquired falls below the necessary number of slots indicating the number of slots necessary to be reserved for holding an event.

3. The schedule adjustment device according to claim 1, further comprising:
presentation instructions configured to cause at least one of said at least one processors to present the candidate slots to participant terminals used by participants of an event; and
receiving instructions configured to cause at least one of said at least one processors to receive registration of participation information indicating whether or not to participate in the event to be held in the candidate slot from the participant terminals for each of the candidate slots, wherein
the unavailability conditions are satisfied when participation information indicating being able to participate is received from a number of participants exceeding the maximum number of persons allowed to participate in an event for the necessary number of slots indicating the number of slots necessary to be reserved for holding an event, or when the number of participants from whom participation information indicating being able to participate is received falls below the minimum number of persons required to hold an event for the necessary number of slots.

4. The schedule adjustment device according to claim 1, wherein
the schedule adjustment device can acquire reservation information related to slots for which reservations are accepted by communication with a reservation system that accepts reservations for slots for holding an event,
the schedule adjustment device further comprises:
acquisition instructions configured to cause at least one of said at least one processors to acquire reservation information related to slots for which reservations are accepted from the reservation system;
presentation instructions configured to cause at least one of said at least one processors to present the candidate slots to participant terminals used by participants of an event; and
receiving instructions configured to cause at least one of said at least one processors to receive registration of participation information indicating whether or not to participate in the event to be held in the candidate slot from the participant terminals for each of the candidate slots, wherein
the unavailability conditions are satisfied when the number of available reservation slots being the candidate slots for which registration of the participation information indicating being unable to participate is not made and which are not reserved in the reservation information acquired falls below the necessary number of slots indicating the number of slots necessary to be reserved for holding the event and set by the organizer terminal or the schedule adjustment device.

5. The schedule adjustment device according to claim 2, wherein
the notification instructions are further configured to cause at least one of said at least one processors to make a determination as to whether the unavailability conditions are satisfied when the reservation information is acquired from the reservation system.

6. The schedule adjustment device according to claim 3, wherein
the notification instructions are further configured to cause at least one of said at least one processors to make a determination as to whether the unavailability conditions are satisfied when registration of the participation information is received from the participant terminals.

7. The schedule adjustment device according to claim 3, wherein
the notification instructions are further configured to cause at least one of said at least one processors to make a determination as to whether the unavailability conditions are satisfied when a registration of the participation information is received from a participant terminal whose participation information has not been registered.

8. The schedule adjustment device according to claim 4, wherein
the notification instructions are further configured to cause at least one of said at least one processors to make a determination as to whether the unavailability conditions are satisfied when the reservation information is received from the reservation system after registration of the participation information from all of the participant terminals to whom candidate slots have been presented is received.

9. The schedule adjustment device according to claim 1, wherein
the candidate slots have a temporal attribute and a geographic attribute,
the schedule adjustment device further comprises extraction instructions configured to cause at least one of said at least one processors to extract one or more slots having an attribute temporally or geographically closest to any candidate slot of the candidate slots among the slots available for reservation in the reservation system that accepts reservations for slots for holding an event, and
the notification instructions is further configured to cause at least one of said at least one processors to notify recommendation information containing the slots extracted as candidate slots to the organizer terminal.

10. The schedule adjustment device according to claim 1, further comprising:
presentation instructions configured to cause at least one of said at least one processors to present the candidate slots to participant terminals used by participants of an event; and
receiving instructions configured to cause at least one of said at least one processors to receive registration of participation information indicating whether or not to participate in the event to be held in the candidate slot from the participant terminals for each of the candidate slots, wherein
when additional setting of candidate slots from the organizer terminal is received after notifying the organizer terminal of a fact that the unavailability conditions are satisfied, the presentation instructions cause at least one of said at least one processors to present the candidate slots related to the additional setting to the participant terminals from whom registration of the participation information has been received.

11. A schedule adjustment method in a schedule adjustment device for assisting an organizer holding an event by inviting participants to decide a slot for holding the event, the slot at least containing information about date and time, the method performed by at least one computer processor and comprising:
in a case when a plurality of candidate slots for holding an event set by an organizer terminal used by the organizer satisfy predetermined unavailability conditions, notifying the organizer terminal of that fact.

12. (canceled)

13. The schedule adjustment device according to claim 4, wherein
the notification instructions are further configured to cause at least one of said at least one processors to make a determination as to whether the unavailability conditions are satisfied when the reservation information is acquired from the reservation system.

14. The schedule adjustment device according to claim 4, wherein
the notification instructions are further configured to cause at least one of said at least one processors to make a determination as to whether the unavailability conditions are satisfied when a registration of the participation information is received from the participant terminals.

15. The schedule adjustment device according to claim 4, wherein
the notification instructions are further configured to cause at least one of said at least one processors to make a determination as to whether the unavailability conditions are satisfied when a registration of the participation information is received from a participant terminal whose participation information has not been registered.
